(19) United States
(12) Patent Application Publication
(10) Pub. No.: US 2026/0188081 A1
(43) Pub. Date: Jul. 2, 2026

(54) PRODUCT PROVIDING DEVICE AND PRODUCT PROVIDING SYSTEM

(71) Applicant: BANDAI CO., LTD., Tokyo (JP)

(72) Inventors: Junichi OSUKI, Tokyo (JP); Satoshi SAKASAI, Tokyo (JP); Yukari AKKA, Tokyo (JP); Ryo INOUE, Tokyo (JP); Hideaki NAKANO, Hokkaido (JP); Shigeki FUJIWARA, Hokkaido (JP)

(21) Appl. No.: 19/549,006

(22) Filed: Feb. 25, 2026

Related U.S. Application Data
(63) Continuation of application No. PCT/JP2023/037914, filed on Oct. 19, 2023.

(30) Foreign Application Priority Data
Sep. 15, 2023 (JP) 2023-150592

(51) Int. Cl. G07F 17/42; G06Q 20/12

(52) U.S. Cl. CPC G07F 17/42; G06Q 20/123

(57) ABSTRACT

A product providing device is capable of communicating with a terminal of a user. The product providing device includes: a first-type option presentation unit which presents a plurality of first-type options on a terminal to be selectable by a user; a second-type option presentation unit which presents, on the terminal, a plurality of second-type options associated with a first-type option selected by a user among the plurality of first-type options, to be selectable by a user; a payment processing unit which performs payment processing for consideration corresponding to a number of at least one second-type option selected by a user; and a product providing unit which presents, on the terminal, product information of at least one product corresponding to the number of at least one second-type option selected by a user after payment processing by the payment processing unit.

The contents of the following patent application(s) are incorporated herein by reference:

NO. 2023-150592 filed in JP on Sep. 15, 2023, and

NO. PCT/JP2023/037914 filed in WO on Oct. 19, 2023.

### BACKGROUND

### 1. Technical Field

The present invention relates to a product providing device and a product providing system.

### 2. Related Art

Conventionally, there is a product providing system of an online lottery format (for example, Patent Document 1). In a case of such an online lottery format, unlike an option such as a tangible lottery box or lottery ticket, a user cannot occupy an option, and thus it is necessary that a system ensures that an option, such as a lottery box or a lottery ticket, selected by the user cannot be selected by another user.

### RELATED ART DOCUMENTS

### Patent Documents

Patent Document 1: Japanese Patent Application Publication No. 2005-070937.

### BRIEF DESCRIPTION OF DRAWINGS

FIG. 1 is a diagram for explaining a product providing method applied to the present embodiment.

FIG. 2 is a schematic diagram of a product providing device according to the present embodiment.

FIG. 3 is a diagram illustrating a device configuration example of a tablet computer which is an example of a terminal 2.

FIG. 4 is a block diagram illustrating a functional configuration example of a product providing device 1.

FIG. 5 is a diagram illustrating an example of a database for a title XXX series.

FIG. 6 is a block diagram illustrating a functional configuration example of the terminal 2.

FIG. 7 is an operation flowchart of first-type option presentation processing of the product providing device 1.

FIG. 8 is an example of a purchasable title list screen presented on the terminal 2.

FIG. 9 is an example of a lottery box list screen presented on the terminal 2.

FIG. 10 is an example of product information of a lottery box 1 presented on the terminal 2 when a user selects the lottery box 1.

FIG. 11 is an operation flowchart of second-type option presentation processing of the product providing device 1.

FIG. 12 is an example of a lottery ticket purchase screen displayed on the terminal 2.

FIG. 13 is an example of a lottery ticket list screen of a selected lottery box displayed on the terminal 2.

FIG. 14 is an example of a payment processing completion screen.

FIG. 15 is an example of a lottery ticket opening screen displayed on the terminal 2.

FIG. 16 is a diagram illustrating an example of a lottery box database D1 according to a first modification of the embodiment of the present invention.

FIG. 17 is an example of a bonus product provision screen displayed on the terminal 2 by a product providing unit 115.

FIG. 18 is an example of the lottery box database D1 according to a second modification of the embodiment of the present invention.

FIG. 19 is an example of the lottery box list screen according to the second modification of the embodiment of the present invention.

### DESCRIPTION OF EXEMPLARY EMBODIMENTS

### Embodiment of Present Invention

A first embodiment of the present invention will be described.

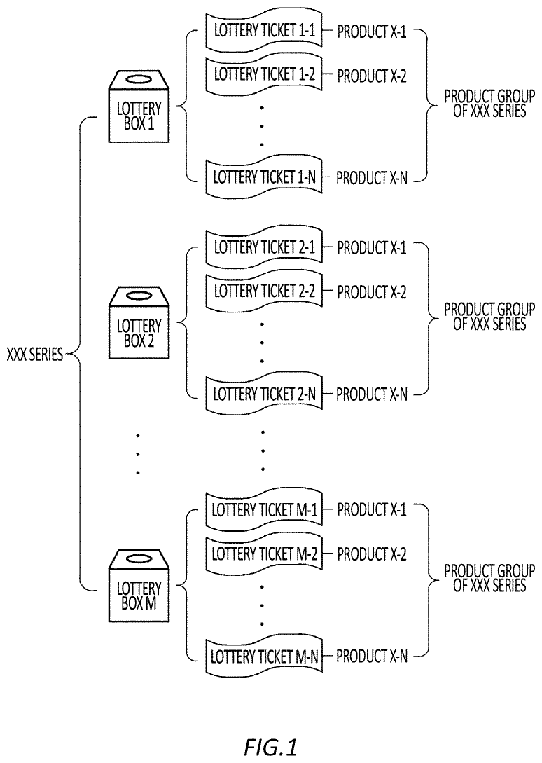

First, in order to facilitate understanding of a configuration of the present embodiment, a product providing method applied to the present embodiment will be described. FIG. 1 is a diagram for explaining the product providing method applied to the present embodiment.

The product providing method applied to the present embodiment provides a product through a draw from a plurality of types of products belonging to a title selected by a user. The title is a name of a certain character or event or the like.

One title is associated with a plurality of first-type options, and each of the plurality of first-type options is associated with a plurality of second-type options. Each of the first-type options is associated with a product group including N products of P types associated with the title. Then, each of the plurality of second-type options associated with each first-type option is associated with any one product in the product group associated with the first-type option.

More specifically, with reference to FIG. 1, the first-type option is a lottery box, and the second-type option is a lottery ticket contained in the lottery box. Then, there is one title “XXX series”, and each of a plurality of lottery boxes 1 to M associated with the title “XXX series” is associated with one product group. A number of at least one product type belonging to each product group is P, each product group comprises of a total of N products of P types, and the products in each product group are identical in type and quantity. A ratio of quantities of products belonging to one product group is determined by prize grades set for respective product types. That is, the quantity of products is smaller as a rank of the prize grade of the products is higher, and the quantity of products is larger as the rank of the prize grade of the products is lower. For example, when “product X-1” of a product group of “XXX series” is set as a first prize grade, “product X-2” is set as a second prize grade, . . . , and “product X-P” is set as a P-th prize grade, a probability of winning increases in order of “product X-1”, “product X-2”, . . . , and “product X-P”. That is, a probability of winning the “product X-1” is the lowest, and its quantity is the smallest. A probability of winning the “product X-P” is the highest, and its quantity is the largest.

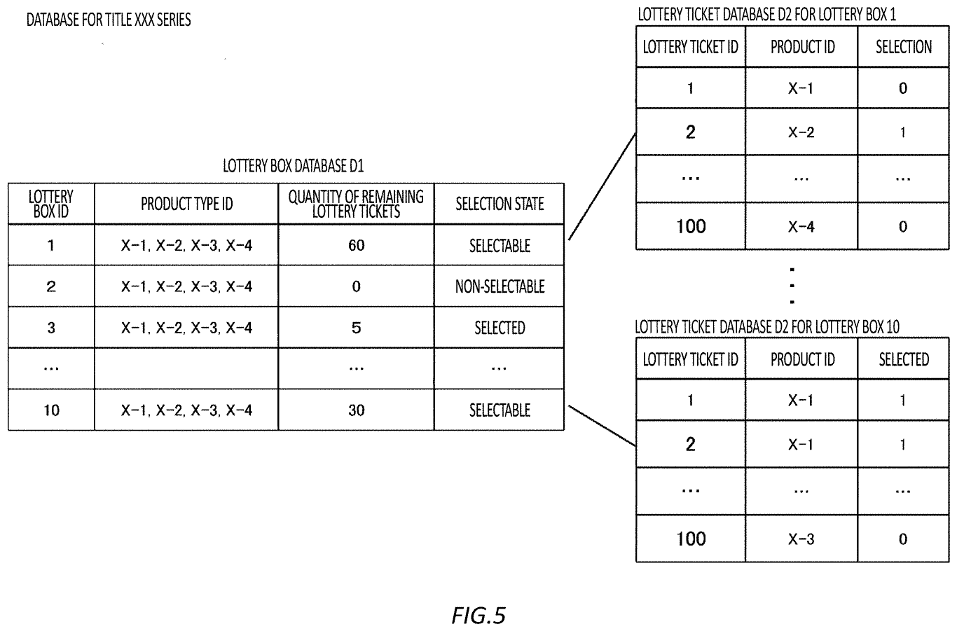

Here, in FIG. 5, a case will be described in which M=10, N=100, and P =5.

The title “XXX series” is associated with ten lottery boxes 1 to 10, and the lottery boxes 1 to 10 are associated with 100 lottery tickets 1 to 100, respectively. There are five types of products in one product group associated with each of the lottery boxes 1 to 10, that is, “product X-1” to “product X-5”, where the first prize grade is “product X-1”, the second prize grade is “product X-2”, the third prize grade is “product X-3”, the fourth prize grade is “product X-4”, and the fifth prize grade is “product X-5”, a breakdown of their quantities is 2 units of “product X-1”, 8 units of “product X-2”, 20 units of “product X-3”, 30 units of “product X-4”, and 40 units of “product X-5”, and a total quantity thereof is 100. That is, each product group of 5 types and 100 products is associated with each of the lottery boxes 1 to 10.

Further, each of the lottery tickets 1 to 100 of each of the lottery boxes 1 to 10 is associated with any one of 100 products of the product group associated with the lottery box. The lottery tickets 1 to 100 and the products are associated on a one-to-one basis without duplication. At this time, it is preferable that the association between the lottery tickets 1 to 100 of each of the lottery boxes 1 to 10 and the products is not identical and varies for each lottery box. This is to prevent the user from figuring out a correspondence relationship between the lottery ticket and the product while the user repeats selection of the lottery ticket.

Next, provision of a product to the user will be described. The user selects a title they intend to purchase, and selects one lottery box of the plurality of lottery boxes 1 to 10 associated with the title. Here, when the user selects the lottery box 5, the user further selects a desired quantity of lottery ticket(s) from lottery tickets 5-1 to 5-100 associated with the lottery box 5. Then, a product(s) associated with the lottery ticket(s) selected by the user is provided. Note that the lottery ticket(s) which has been selected by the user and for which the product(s) has been provided cannot be selected by another user.

In this way, provision of a product associated with a title is achieved by a lottery method in which the user makes their own selection.

### Overall Configuration

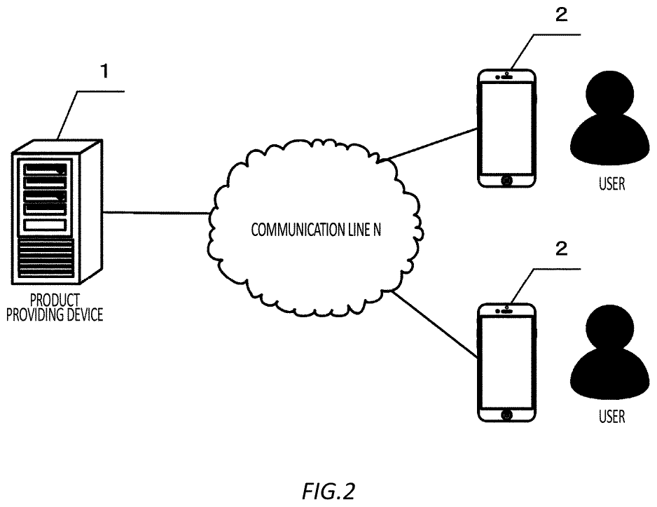

A product providing device system according to the present embodiment will be described. FIG. 2 is a schematic diagram of a product providing device according to the present embodiment. In FIG. 2, reference numeral 1 denotes a product providing device, and reference numeral 2 denotes a terminal of a user.

The product providing device 1 and the terminal 2 of the user can be connected to a communication line N and can communicate with each other. The communication line N means a communication path capable of data communication. That is, the communication line N includes a communication network such as a telephone communication network, a cable network, and the Internet in addition to a LAN by a dedicated line (dedicated cable), Ethernet (registered trademark), or the like for direct connection, and a communication method may be wired or wireless.

The product providing device 1 is a server system including a single server device or a plurality of server devices, a storage device, and the like. The product providing device 1 performs various services for providing a product to a user, acquires a product inventory status, and the like, and performs a procedure for providing the product to the user, and the like.

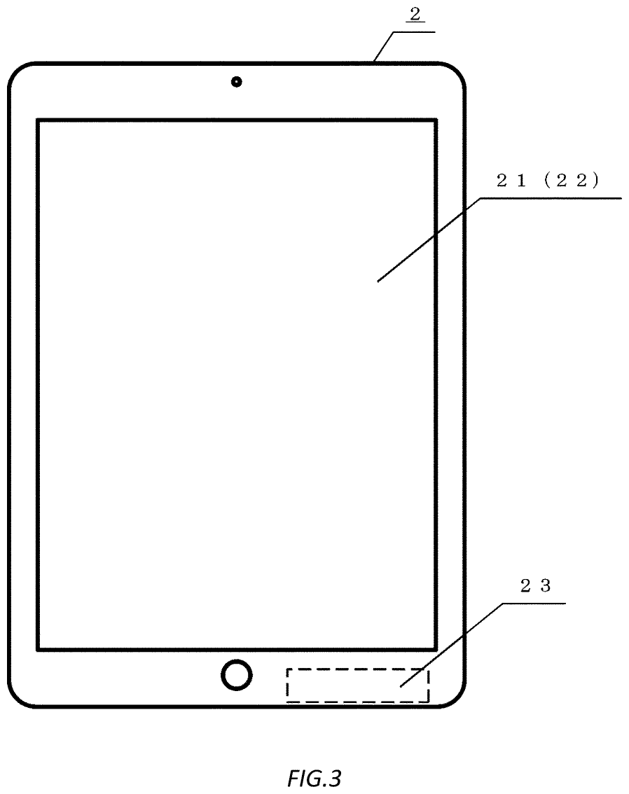

The terminal 2 is, for example, a personal computer, a tablet computer, a smartphone, a mobile phone, or the like. FIG. 3 is a diagram illustrating a device configuration example of a tablet computer which is an example of the terminal 2. As illustrated in FIG. 3, the terminal 2 includes a display 21, a touch operation panel 22 integrated with the display 21, and a built-in speaker 23. In addition, the terminal 2 is provided with a control board, a built-in battery, a power button, a volume adjustment button, and the like which are not illustrated.

Various microprocessors such as a CPU, a GPU, and a DSP, various IC memories such as an ASIC, a VRAM, a RAM, and a ROM, a wireless communication module for wirelessly communicating with a base station, and the like are mounted on the control board. In addition, a so-called I/F circuit (interface circuit), such as a driver circuit of the touch operation panel 22, and the like is mounted on the control board. Each element mounted on the control board is individually connected electrically via a bus circuit or the like, and is connected so as to be able to read and write data and transmit and receive a signal.

The product is a product to be provided to the user and is a product to be sold to the user by a seller. In the present embodiment, the product is a product to be provided to the user when the user pays consideration. The product is embodied and expressed as a tangible product or the like. For example, the product is a molded object such as a figure having an appearance of a certain character, clothing, a plastic model, an accessory, and the like, but is not limited thereto.

### Functional Configuration

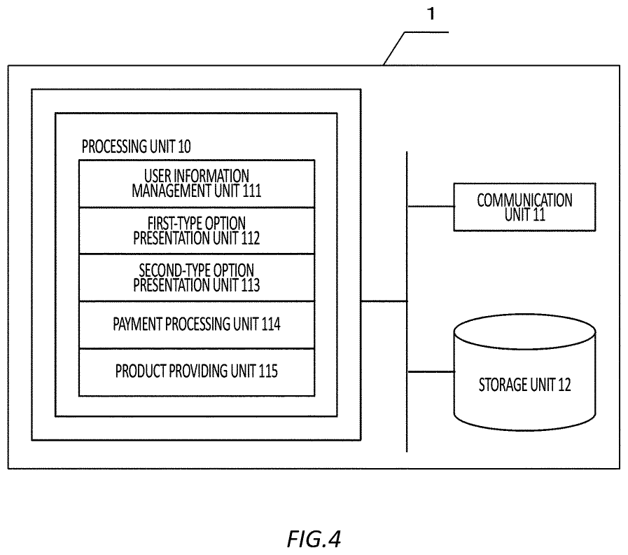

A configuration of each device will be described. First, a configuration of the product providing device 1 will be described. FIG. 4 is a block diagram illustrating a functional configuration example of the product providing device 1.

As illustrated in FIG. 4, the product providing device 1 includes a processing unit 10, a communication unit 11, and a storage unit 12.

The processing unit 10 comprehensively controls an operation of the product providing device 1 based on a program and data stored in the storage unit 12. A function of the processing unit 10 can be implemented by, for example, a microprocessor such as a CPU or a GPU, or an electronic component such as an ASIC or an IC memory. The processing unit 10 includes, as main functional units, a user information management unit 111, a first-type option presentation unit 112, a second-type option presentation unit 113, a payment processing unit 114, and a product providing unit 115.

The user information management unit 111 manages user information by using a user information database. The user information includes identification information (user ID) and a password of the user for a purchase service, personal information of the user such as a name and an address, product purchase history information of the user, and the like.

The first-type option presentation unit 112 refers to a lottery box database D1 and controls presentation of a plurality of first-type options to the terminal 2. FIG. 5 is a diagram illustrating an example of a database for a title XXX series. The database includes the lottery box database D1 and a lottery ticket database D2 to be described later. The lottery box database D1 includes, for each lottery box, a lottery box ID (identification information), a product type ID (identification information) for types of products included in the lottery box, a quantity of remaining lottery tickets in the lottery box, and selection state information of the lottery box. The selection state information of the lottery box is any of a selectable state, a selected state, or a non-selectable state. The selectable state is a state in which the user can select the lottery box. The selected state is a state in which another user is selecting the lottery box, and when selection (holding) of the user is released, the lottery box can be selected. The non-selectable state is a state in which all lottery tickets associated with the lottery box have been selected (opened) and the lottery tickets in the lottery box cannot be selected.

Every time the user selects the lottery box, the first-type option presentation unit 112 updates, to the selected state, the selection state information of the lottery box in the lottery box database D1. A reason for this is that, if a lottery box is made selectable by a plurality of users in a duplicate manner, a lottery ticket of the lottery box can also be selected by the users in a duplicate manner, and provision of a product associated with the lottery ticket cannot be accurately performed. On the other hand, if a user is allowed to select a lottery box for a long time, another user cannot select the lottery box. In this regard, the first-type option presentation unit 112 measures a time T1 from selection of a lottery box by a user to purchase decision of a lottery ticket of the lottery box, and when the time T1 exceeds a predetermined TX, forcibly releases the selection of the lottery box, transitions to the selectable state, and updates the lottery box to the selectable state in the lottery box database D1.

Note that, in the present embodiment, a lottery box (first-type option) is selected by the user, but a configuration is made such that the user can select either manual selection or automatic selection, and when the automatic selection is selected, the first-type option presentation unit 112 may be able to automatically select the lottery box (first-type option) in the selectable state through a draw.

The second-type option presentation unit 113 refers to the lottery ticket database D2 and controls presentation of a plurality of second-type options to the terminal 2. In the present embodiment, the second-type option is a lottery ticket. As illustrated in FIG. 5, the lottery ticket database D2 is associated with one lottery box and includes a lottery ticket ID (identification information), a product ID (identification information) of a product associated with the lottery ticket ID, and selection state information of the lottery ticket. The selection state information of the lottery ticket includes a selection state in which a lottery ticket has been already selected (opened) by the user and a product associated with the lottery ticket has been provided, and an unselected state in which the product associated with the lottery ticket has not yet been provided. In the selected state, “1” is assigned, and in the unselected state, “0” is assigned.

The second-type option presentation unit 113 first presents a lottery ticket purchase screen for reserving a purchase quantity, causes the user to decide a quantity of lottery tickets to be purchased, and then presents a lottery ticket list screen including a plurality of lottery tickets to the terminal 2. Note that the lottery ticket already selected by the user is displayed in a mode that the lottery ticket is non-selectable.

In addition, similarly to the lottery box, if a user is allowed to select a lottery ticket for a long time, another user cannot select the lottery box. In this regard, the second-type option presentation unit 113 measures a time T2 from presentation of a purchase screen for a lottery ticket to completion of payment for purchase of the lottery ticket, and when the time T2 exceeds a predetermined TY, forcibly releases the selection of the lottery ticket and also releases the selection of the lottery box. Then, the second-type option presentation unit 113 updates the lottery box to the selectable state in the lottery box database D1. Note that, regarding a relationship between a time TX and a time TY, it is preferable that the time TY is longer than the time TX, considering that it takes more time to select the lottery ticket.

Note that, in the present embodiment, a lottery ticket (second-type option) is selected by the user, but a configuration is made such that the user can select either manual selection or automatic selection, and when the automatic selection is selected, the second-type option presentation unit 113 may be able to automatically select the lottery ticket (second-type option) in the selectable state through a draw.

The payment processing unit 114 performs payment processing for a lottery ticket for which purchase reservation has been made. The payment processing is performed after the lottery ticket is selected and confirmed by the second-type option presentation unit 113. Note that, when the payment processing by the payment processing unit 114 is completed, the second-type option presentation unit 113 updates the lottery box database D1 to transition the selected lottery box from the selected state to the selectable state. In this way, by performing the payment after a type of a product associated with the selected lottery ticket is confirmed and a type of a product to be provided to the user is confirmed, the lottery box can be transitioned from the selected state to the selectable state without waiting for a time required for product provision, such as its subsequent opening animation of the lottery ticket.

The product providing unit 115 presents a lottery ticket opening screen. When the user selects a lottery ticket to be opened, product information of a product associated with the opened lottery ticket is presented. The product providing unit 115 updates, to the selected state, selection state information corresponding to the lottery ticket ID of the opened lottery ticket in the lottery ticket database D2. In addition, the product providing unit 115 performs a shipping procedure of the product provided to the user. As a delivery destination address, an address registered in the user information database is selected.

The communication unit 11 is connected to the communication line N to implement communication.

The storage unit 12 stores a system program and a functional program. The system program is a program for implementing a basic function of the product providing device 1 as a computer. The functional program is a program for causing the processing unit 10 to function as the user information management unit 111, the first-type option presentation unit 112, the second-type option presentation unit 113, the payment processing unit 114, and the product providing unit 115 as main functional units. In addition, the storage unit 12 also stores the lottery box database D1 and the lottery ticket database D2.

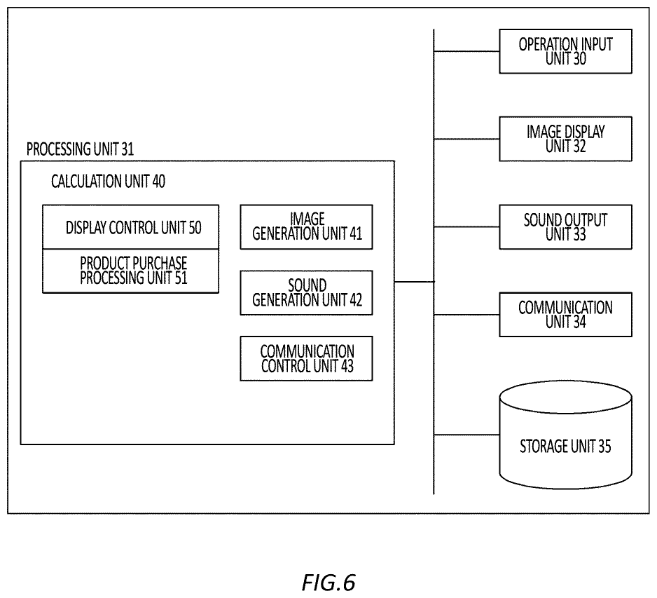

Next, a configuration of the terminal 2 will be described. FIG. 6 is a block diagram illustrating a functional configuration example of the terminal 2.

As illustrated in FIG. 6, the terminal 2 includes an operation input unit 30, a processing unit 31, an image display unit 32, a sound output unit 33, a communication unit 34, and a storage unit 35.

The operation input unit 30 is for inputting various operations of the user, and outputs, to the processing unit 31, an operation input signal corresponding to an operation input. A function of the operation input unit 30 can be implemented by, for example, not only an element directly operated by the user with a finger, such as a touch operation pad, a home button, a button switch, a joystick, or a trackball, but also an element that detects motion or posture, such as an acceleration sensor, an angular velocity sensor, an inclination sensor, or a geomagnetic sensor. In FIG. 2, the touch operation panel 22 corresponds to this.

The processing unit 31 comprehensively controls an operation of the terminal 2 based on the program and data stored in the storage unit 35, the operation input signal from the operation input unit 30, and the like. A function of the processing unit 31 can be implemented by, for example, a microprocessor such as a CPU or a GPU, or an electronic component such as an ASIC or an IC memory. The processing unit 31 includes, as main functional units, a calculation unit 40, an image generation unit 41, a sound generation unit 42, and a communication control unit 43.

The calculation unit 40 executes various types of processing for purchasing a product 3, and outputs the result to the image generation unit 41, the sound generation unit 42, and the communication control unit 43. The calculation unit 40 includes a display control unit 50 and a product purchase processing unit 51.

The display control unit 50 performs display, animation, and the like for a product purchase screen of the product 3 by using information provided from the product providing device 1 and user operation information.

The product purchase processing unit 51 performs a product purchase procedure. Specifically, the purchase processing for the product 3 is performed with the product providing device 1.

The image generation unit 41 generates one image in one frame time (for example, 1/60 seconds) based on a processing result of the calculation unit 40, and outputs the generated image signal to the image display unit 32. A function of the image generation unit 41 can be implemented by, for example, a processor such as a GPU or a digital signal processor (DSP), a program such as a video signal IC or a video codec, an IC memory for a drawing frame such as a frame buffer, an IC memory used for developing texture data, or the like.

The sound generation unit 42 generates a sound signal such as a sound effect and various operation sounds based on the processing result of the calculation unit 40, and outputs the sound signal to the sound output unit 33. A function of the sound generation unit 42 can be implemented by, for example, a processor such as a digital signal processor (DSP) or an audio synthesis IC, an audio codec capable of reproducing an audio file, or the like.

The communication control unit 43 performs communication connection and data processing for data communication with the product providing device 1.

The image display unit 32 displays a screen based on the image signal input from the image generation unit 41. A function of the image display unit 32 can be implemented by, for example, a display device such as a flat panel display, a cathode ray tube (CRT), a projector, or a head mounted display. In FIG. 2, the image display unit 32 corresponds to the display 21.

The sound output unit 33 outputs a sound effect or the like based on the sound signal input from the sound generation unit 42. In FIG. 2, the sound output unit 33 corresponds to the speaker 23.

The communication unit 34 is connected to the communication line N to implement communication. A function of the communication unit 34 can be implemented by, for example, a wireless communication device, a modem, a terminal adapter (TA), a jack of a wired communication cable, a control circuit, or the like.

In the storage unit 35, a program for operating the terminal 2 and implementing various functions included in the terminal 2, data used during execution of the program, and the like are stored in advance, or temporarily stored each time processing is performed. The storage unit 35 can be implemented by, for example, an IC memory such as a RAM, a ROM, or a flash memory, a magnetic disk such as a hard disk, an optical disk such as a CD-ROM or a DVD, or the like. Specifically, the storage unit 35 stores a system program and a control program for controlling purchase processing of an article (product) 3 by the terminal 2. The system program is a program for implementing a basic function of the terminal 2 as a computer. The control program is a program for causing the processing unit 31 to function as the calculation unit 40.

### Description of Operation

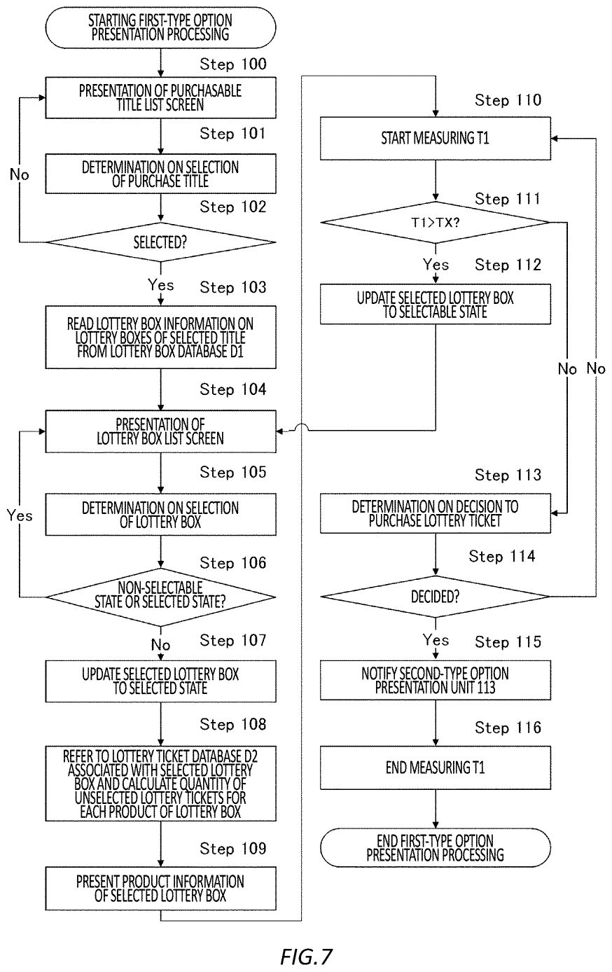

An operation of the product providing system according to the present embodiment will be described focusing on an operation of product providing device 1. FIG. 7 is an operation flowchart of first-type option presentation processing of the product providing device 1.

First, the user accesses the product providing device 1 by using the terminal 2 and requests a product purchase screen.

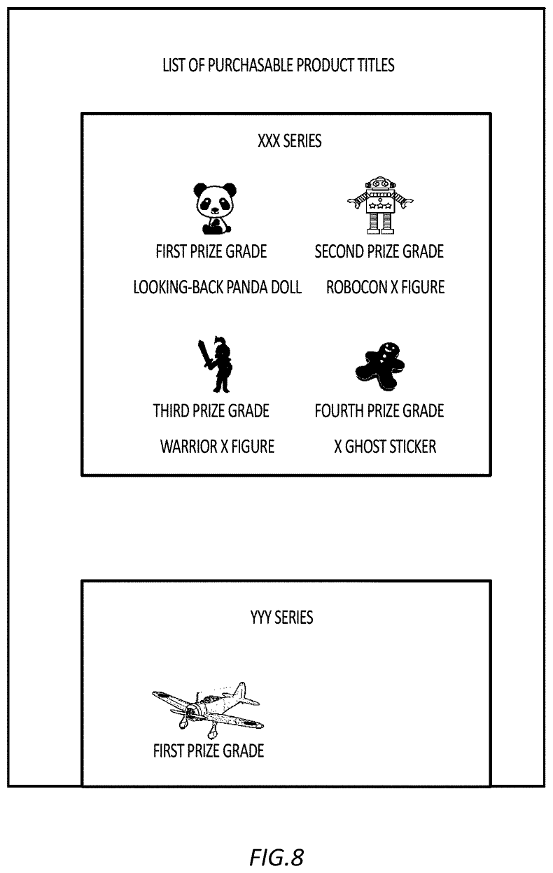

The first-type option presentation unit 112 of the product providing device 1 that has received the request for the product purchase screen presents a purchasable title list screen on the terminal 2 (Step 100). FIG. 8 is an example of the purchasable title list screen presented on the terminal 2. On the purchasable title list screen, for each title, a description of types of products belonging to a product group associated with the title is also displayed. The user selects a title they wish to purchase. In the present example, it is assumed that the user selects a title “XXX series”.

The first-type option presentation unit 112 performs a determination on selection of a purchase title (Step 101), and if the purchase title is selected (Step 102), reads lottery box information from the lottery box database D1 for the selected title (Step 103). The lottery box information is the lottery box ID, the quantity of remaining lottery tickets, and the selection state information of the lottery box.

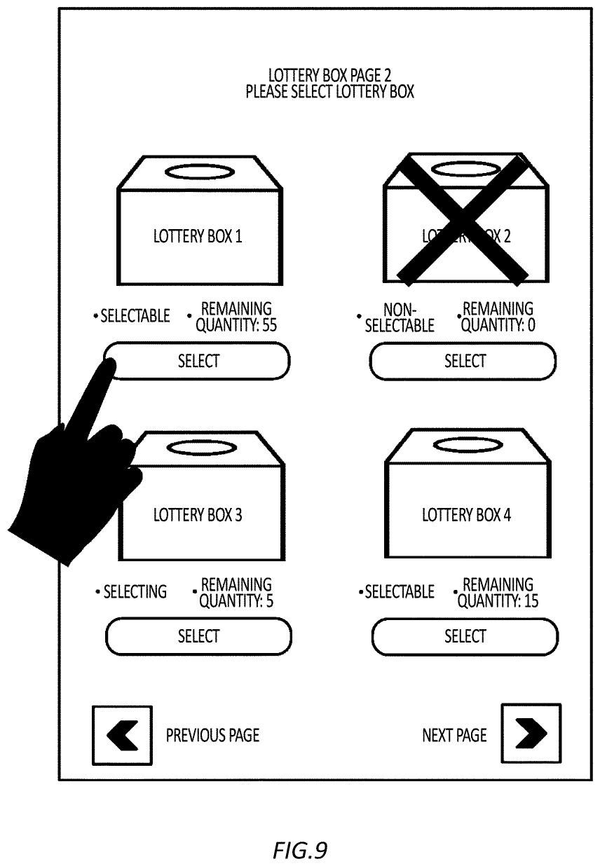

The first-type option presentation unit 112 presents the lottery box list screen on the terminal 2 by using the read lottery box information (Step 104). The first-type option presentation unit 112 also presents, for each lottery box, the state of the lottery box (selectable state, non-selectable state, selected state) and the quantity of remaining lottery tickets in the lottery box. FIG. 9 is an example of the lottery box list screen presented on the terminal 2. The example of FIG. 9 is an example in which the lottery boxes 1 to 4 among the lottery boxes 1 to 10 with the title “XXX series” are displayed. When the user browses the lottery box 5 and the subsequent boxes, the user can browse the boxes by selecting a next page. Each of the lottery boxes 1 to 4 presents the state of the lottery box (selectable state, non-selectable state, selected state) and the quantity of remaining lottery tickets in the lottery box. For example, the lottery box 1 is in the selectable state, and the quantity of remaining lottery tickets is 55. The lottery box 2 is in the non-selectable state, and the quantity of remaining lottery tickets is zero. The lottery box 3 is in the selected state, and the quantity of remaining lottery tickets is five. The lottery box 4 is in the selectable state, and the quantity of remaining lottery tickets is 15.

The user selects a desired lottery box from the lottery boxes displayed on the terminal 2. The first-type option presentation unit 112 performs a determination on selection of a lottery box (Step 105). If the selected lottery box is in the non-selectable state or the selected state (Step 106), the first-type option presentation unit 112 returns to Step 104 and waits for selection of a new lottery box. On the other hand, if the selected lottery box is in the selectable state, the first-type option presentation unit 112 updates the selection state information of the lottery box ID of the lottery box to the selected state in the lottery box database D1 (Step 107).

The first-type option presentation unit 112 refers to the lottery ticket database D2 associated with the selected lottery box, and calculates the quantity of unselected lottery tickets for each product of the lottery box (Step 108).

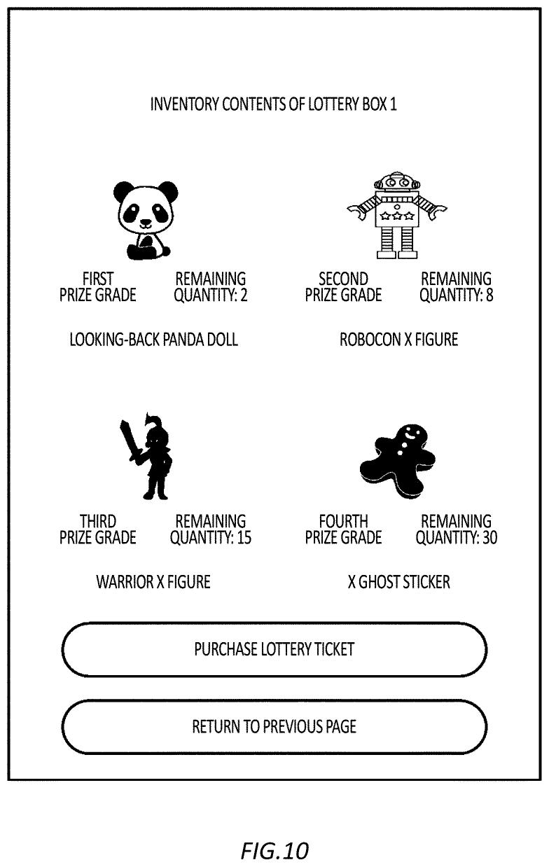

The first-type option presentation unit 112 presents the product information of the selected lottery box on the terminal 2 (Step 109). FIG. 10 is an example of the product information of the lottery box 1 presented on the terminal 2 when the user selects the lottery box 1. In the example of FIG. 10, it is displayed that the lottery box 1 contains two lottery tickets for “Looking-Back Panda Doll” as the first prize grade, eight lottery tickets for “Robocon X Figure” as the second prize grade, 15 lottery tickets for “Warrior X Figure” as the third prize grade, and 30 lottery tickets for “X Ghost Sticker” as the fourth prize grade. In addition, a lottery ticket purchase decision button for purchasing a lottery ticket of the lottery box of the displayed product information is also displayed in the product information.

When the product information of the lottery box is presented on the terminal 2, the first-type option presentation unit 112 starts measuring the time T1 (Step 110). Here, the time T1 is a time from presentation of the product information of the lottery box to decision of a reserved quantity of lottery tickets to be purchased for that lottery box.

The first-type option presentation unit 112 determines whether or not the time T1 exceeds the predetermined time TX (Step 111). If the time T1 exceeds the time TX, the first-type option presentation unit 112 updates the selected lottery box (the lottery box displaying the product information) from the selected state to the selectable state (Step 112), and returns the screen of the terminal 2 to the lottery box list screen (Step 104). If the time T1 does not exceed the time TX, the first-type option presentation unit 112 performs a determination on decision to purchase the lottery ticket in the selected lottery box (Step 113). If it is decided to purchase the lottery ticket in the selected lottery box (Step 114), the first-type option presentation unit 112 notifies the second-type option presentation unit 113 of the fact (Step 115), and ends measuring the time T1 (Step 116).

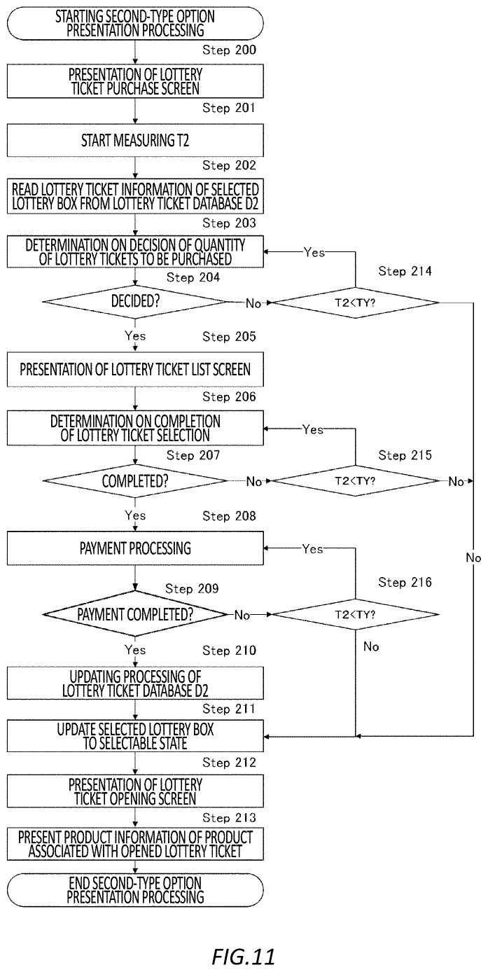

Next, second-type option presentation processing will be described. FIG. 11 is an operation flowchart of the second-type option presentation processing of the product providing device 1.

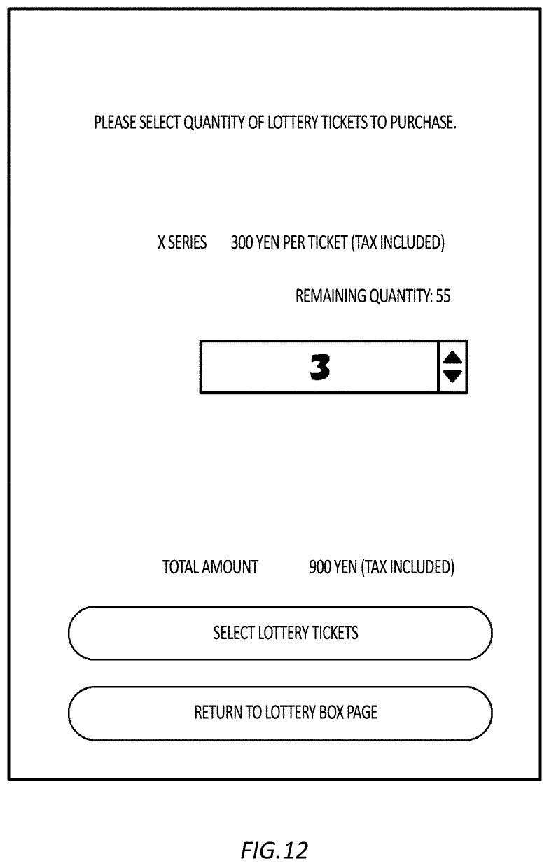

First, the second-type option presentation unit 113 presents a lottery ticket purchase screen on the terminal 2 (Step 200). FIG. 12 is an example of the lottery ticket purchase screen displayed on the terminal 2. The user inputs, through the lottery ticket purchase screen, the quantity of lottery tickets to be reserved for purchase.

When presenting the lottery ticket purchase screen on the terminal 2, the second-type option presentation unit 113 starts measuring the time T2 (Step 202). Here, the time T2 is a time from the presentation of the lottery ticket purchase screen to completion of payment for the purchase of the lottery ticket. In addition, the second-type option presentation unit 113 reads the lottery ticket information of the selected lottery box from the lottery ticket database D2 (Step 202). The lottery ticket information to be read is the lottery ticket ID and selection information.

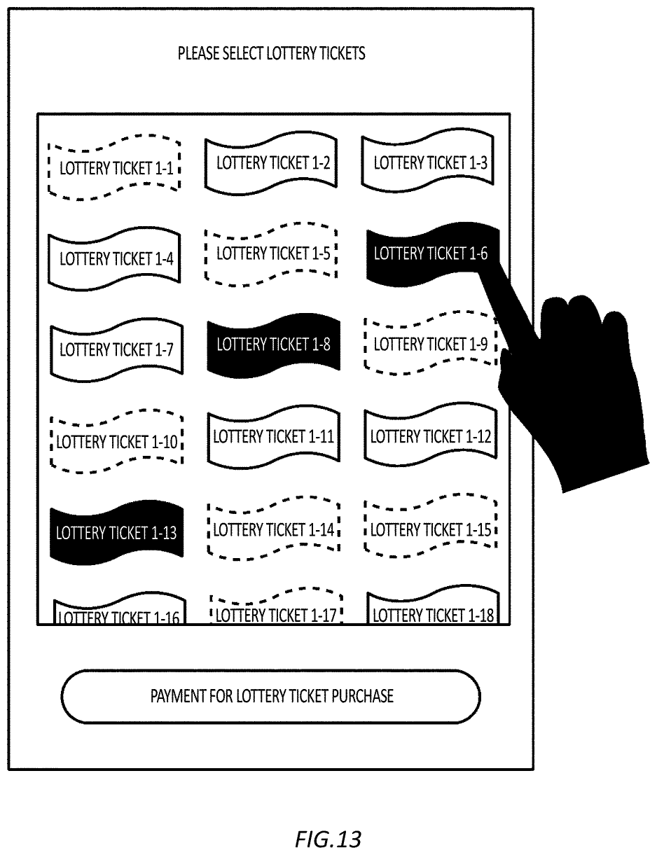

The second-type option presentation unit 113 performs a determination on decision of a reserved quantity of lottery tickets to be purchased (Step 203). If the reserved quantity of lottery tickets to be purchased is decided (Step 204), the second-type option presentation unit 113 presents a lottery ticket list screen of the selected lottery box on the terminal 2 (Step 205). FIG. 13 is an example of the lottery ticket list screen of the selected lottery box displayed on the terminal 2. On the lottery ticket list screen of FIG. 13, images of lottery tickets with already selected lottery ticket IDs are displayed by dotted lines, and selectable lottery tickets are displayed by solid lines. The user can select as many lottery tickets as the quantity reserved for purchase, from among the selectable lottery tickets. On the other hand, if the reserved quantity of lottery tickets to be purchased is not decided, the second-type option presentation unit 113 determines whether or not the time T2 exceeds the predetermined time TY (Step 214). If the time T2 exceeds the time TY, the second-type option presentation unit 113 updates the stat of the selected lottery box from the selected state to the selectable state (Step 211) and stops the processing.

Subsequently, the second-type option presentation unit 113 determines whether the selection of the lottery ticket is completed on the lottery ticket list screen (Step 206). If the selection of the lottery ticket is not completed (Step 207), the second-type option presentation unit 113 determines whether or not the time T2 exceeds the predetermined time TY (Step 215). If the time T2 exceeds the time TY, the second-type option presentation unit 113 updates the selected lottery box from the selected state to the selectable state (Step 211) and stops the processing.

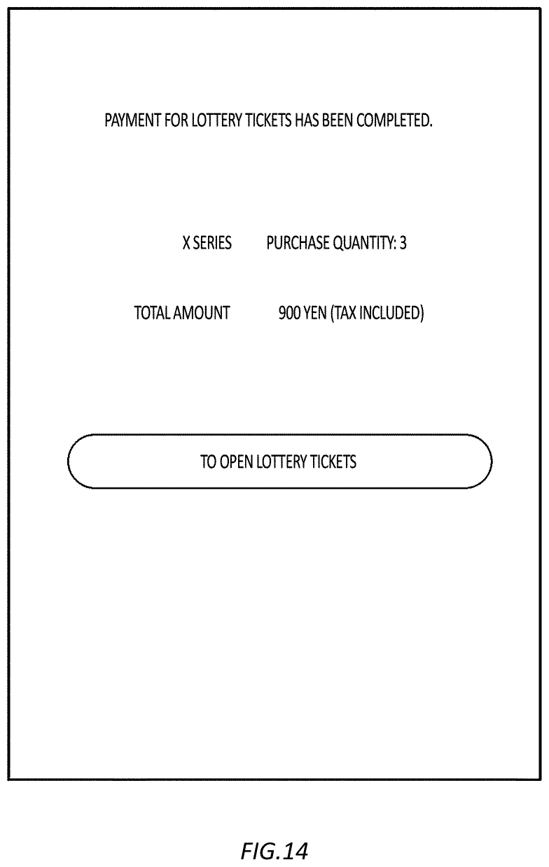

On the other hand, if the selection of the lottery ticket by the user is completed (Step 207), the payment processing unit 114 performs payment processing for the purchase of the lottery ticket (Step 208). FIG. 14 is an example of a payment processing completion screen. Upon completion of the payment processing, for the lottery ticket for which the selection is completed, the second-type option presentation unit 113 writes a flag of “1” in selection information of its lottery ticket ID, and updates the lottery ticket database D2 (Step 210). Further, the second-type option presentation unit 113 updates the lottery box database D1 to transition the selection state information of the selected lottery box from the selected state to the selectable state (Step 211).

Accordingly, the lottery box that was in the selected state by the user enters the selectable state where the lottery box is selectable by another user, whereby another user can select the lottery box. In addition, since, at the time of payment, the selected lottery ticket is confirmed and the product associated with that lottery ticket is also confirmed, information on remaining lottery tickets and products can be accurately transmitted to the user who has selected that lottery box, and the already selected lottery ticket is not selected by another user.

On the other hand, when the payment processing of the payment processing unit 114 is not completed (Step 209), the second-type option presentation unit 113 determines whether or not the time T2 exceeds the predetermined time TY (Step 216). If the time T2 exceeds the time TY, the second-type option presentation unit 113 updates the selection state information of the selected lottery box from the selected state to the selectable state (Step 211) and stops the processing.

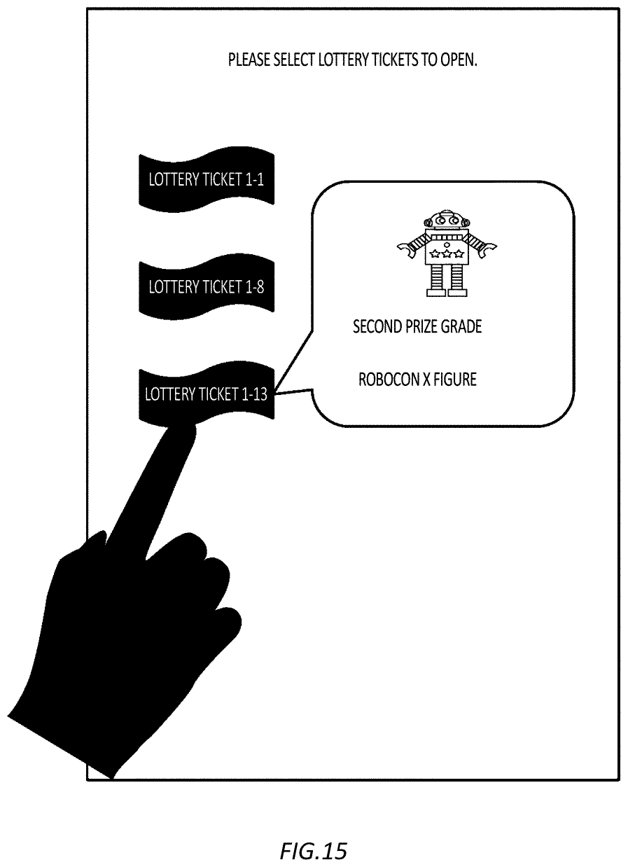

When the payment processing of the payment processing unit 114 is completed (Step 209), the product providing unit 115 presents the lottery ticket opening screen (Step 212), and presents the product information of the product associated with the opened lottery ticket (Step 213). FIG. 15 is an example of the lottery ticket opening screen displayed on the terminal 2. By selecting the lottery ticket to be opened, the user can browse the product information of the product associated with that lottery ticket.

A product providing method applied to the present embodiment is to provide a product in a lottery box format. Therefore, it is necessary to allow only one user to select a lottery box. On the other hand, it is not preferable that one user exclusively select the lottery box. In the present embodiment, the lottery box is configured to be selectable by only one user, the payment for the purchase of the lottery ticket is made after the selection of the lottery ticket by the user is completed, and then an opening operation of the lottery ticket is performed, so that it is possible to shorten a time for which the selection of the lottery box needs to be maintained for one user.

In addition, since one product is associated with the selected lottery ticket, information on remaining lottery tickets and products can be accurately transmitted to a next user who selects that lottery box, and it is possible to prevent provision of duplicate products.

Note that, in the present embodiment, an example of using a plurality of first-type options (lottery boxes) has been described, but it is not always necessary to provide a plurality of first-type options (lottery boxes). Even when the number of first-type options (lottery boxes) is one, similar to the present embodiment, if only one user can select the first-type option (lottery box), a plurality of second-type options (lottery tickets) are associated with the first-type option (lottery box), and the second-type options (lottery tickets) are associated on one-to-one basis with products of a product group of the first-type option (lottery box), a similar effect can be obtained. That is, it is possible to shorten the time for which the selection of the lottery box needs to be maintained for one user, and it is possible to prevent provision of duplicate products.

### First Modification of Embodiment of Present Invention

Adopting product provision with a high level of amusement is advantageous for a user and a product provider. Therefore, in a first modification of the embodiment of the present invention, an example will be described in which a bonus is given to a user who has selected a last lottery ticket remaining in the lottery box.

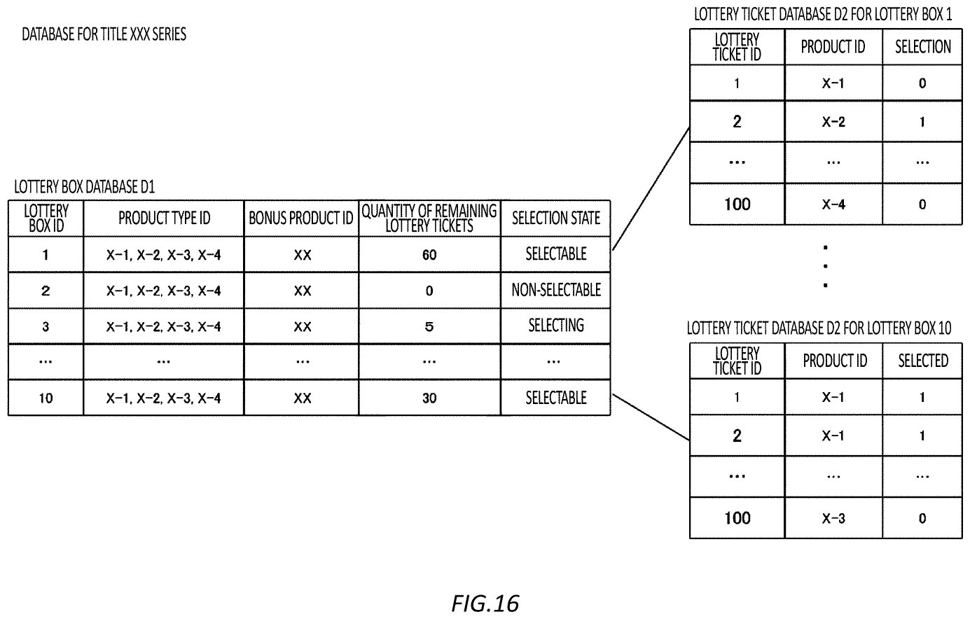

FIG. 16 is a diagram illustrating an example of the lottery box database D1 according to the first modification of the embodiment of the present invention. In the example of FIG. 16, a product XX, which is a bonus product to be given to the user who has selected the last lottery ticket remaining in the lottery box, is described for each lottery box.

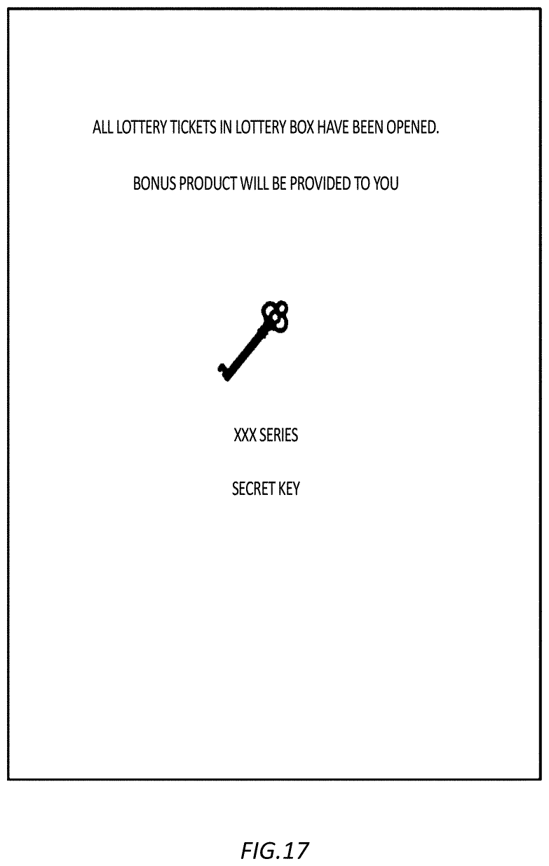

Each time the lottery ticket is opened, the product providing unit 115 refers to the selection state of the lottery ticket database D2, and when the selection states of all the lottery tickets in the lottery ticket database D2 become the selected states, the product providing unit 115 provides the bonus product of the lottery box to the user who has selected the last lottery ticket. FIG. 17 is an example of a bonus product provision screen displayed on the terminal 2 by the product providing unit 115.

With such a configuration, it is possible to provide a product providing system with a high level of amusement.

### Second Modification of Embodiment of Present Invention

In the selected state in which the user selects the lottery box, another user cannot select that lottery box. However, there is a case where another user wishes to select that lottery box. In this regard, even when the lottery box is in the selected state, the user may be allowed to select that lottery box with priority if the selection of the lottery box is released.

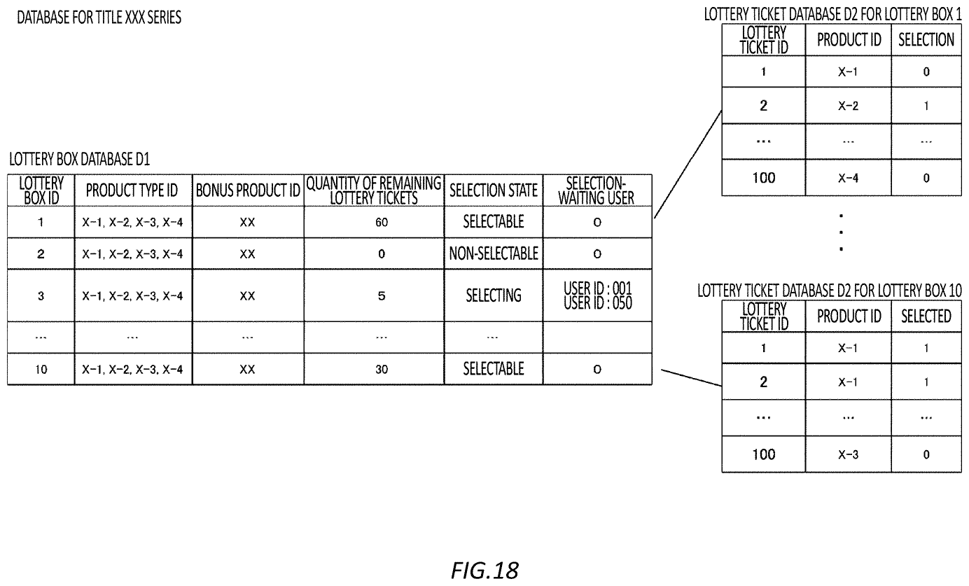

In this case, a field for a number of people waiting for selection of that lottery box is provided in the lottery box database D1, and the number of waiting people is managed. FIG. 18 is an example of the lottery box database D1 according to a second modification of the embodiment of the present invention. In the example of FIG. 18, a selection-waiting user information field for entering the user ID of the user who waits for selection is newly provided in the lottery box database D1.

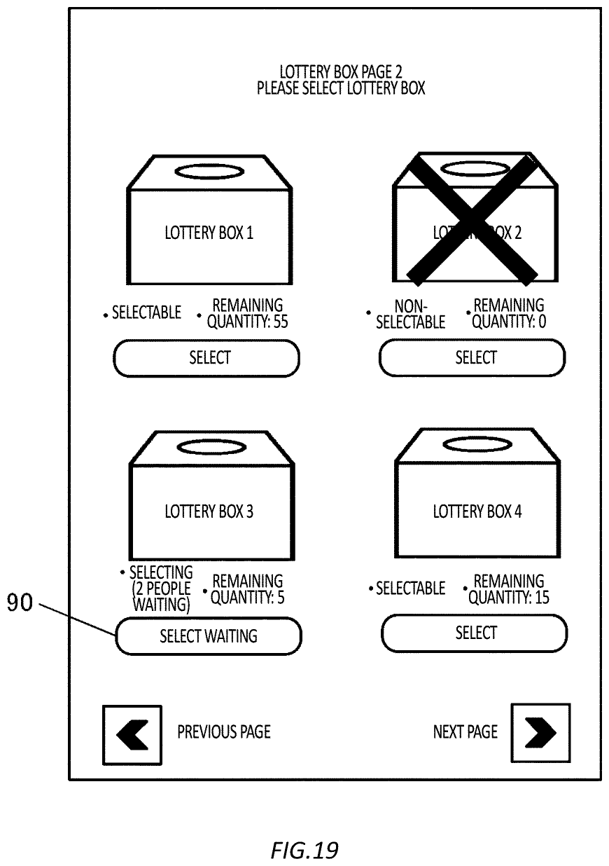

The first-type option presentation unit 112 displays a lottery box list screen as illustrated in FIG. 19, for example, and displays a selection-waiting button 90 for the lottery box in the selected state on the lottery box list screen. Then, when the user selects the selection-waiting button 90, the user ID of that user is written in the selection-waiting user information field of the lottery box database D1, and the number of selection-waiting people is increased.

When the selection state information of the lottery box database D1 transitions from selected to selectable, the first-type option presentation unit 112 refers to the user ID having a highest waiting priority and notifies the user of that user ID. Accordingly, the notified user can select that lottery box. The second modification of the embodiment of the present invention is effective for a system in which a bonus can be given to a user who has selected the last lottery ticket remaining in the lottery box as in the configuration of the first modification of the embodiment of the present invention. This is because it is possible to select the lottery box in consideration of the remaining quantity of the lottery box.

Although the present invention has been described above with reference to embodiments, the present invention is not necessarily limited to the above-described embodiments, and various modifications and implementations can be made within the scope of the technical idea.

### Explanation of References

1: product providing device;
2: terminal;
10: processing unit;
11: communication unit;
12: storage unit;
111: user information management unit;
112: first-type option presentation unit;
113: second-type option presentation unit;
114: payment processing unit; and
115: product providing unit.

What is claimed is:

1. A product providing device capable of communicating with a terminal of a user, comprising:
a first-type option presentation unit which presents a plurality of first-type options on a terminal to be selectable by a user;
a second-type option presentation unit which presents, on the terminal, a plurality of second-type options associated with a first-type option selected by a user among the plurality of first-type options, to be selectable by the user;
a payment processing unit which performs payment processing for consideration corresponding to a number of at least one second-type option selected by a user; and
a product providing unit which presents, on the terminal, product information of at least one product corresponding to the number of at least one second-type option selected by a user after payment processing by the payment processing unit.

2. The product providing device according to claim 1, wherein
one product group including different products is associated with each of the plurality of first-type options,
each of a plurality of second-type options associated with each of the first-type options is associated with any one product in the product group, and
the product providing unit presents, on the terminal, product information of a product associated with a second-type option selected by a user.

3. The product providing device according to claim 2, wherein
the first-type option presentation unit releases selection of a first-type option on condition that payment processing by the payment processing unit is completed.

4. The product providing device according to claim 3, wherein
the first-type option presentation unit controls one first-type option to be selectable by only one user.

5. The product providing device according to claim 4, wherein
the first-type option presentation unit presents each first-type option in any one mode of a selectable state, a selected state, or a non-selectable state.

6. The product providing device according to claim 5, wherein
the first-type option presentation unit presents a first-type option in a mode of the selectable state or the selected state on condition that at least one of a plurality of second-type options associated with the first-type option is selectable, and presents the first-type option in a mode of the non-selectable state on condition that all of the plurality of second-type options associated with the first-type option are non-selectable.

7. The product providing device according to claim 5, wherein
the first-type option presentation unit enables selection of one first-type option only for one user, and presents a selected first-type option in a mode of the selected state until selection is released.

8. The product providing device according to claim 5, wherein
the first-type option presentation unit releases selection of a first-type option on condition that presentation of a second-type option by the second-type option presentation unit is not performed within a predetermined time from the selection of the first-type option.

9. The product providing device according to claim 3, wherein
regarding a first-type option presented in a mode of a selected state, the first-type option presentation unit performs control to enable waiting for the first-type option to be selectable after selection release, and presents a number of at least one waiting user.

10. The product providing device according to claim 5, wherein
the first-type option presentation unit presents, in a browsable manner, product information of products belonging to a product group associated with a first-type option selected by a user.

11. The product providing device according to claim 10, wherein
for each product included in a product group associated with a selected first-type option, the first-type option presentation unit presents a product image of the product and a providable quantity of the product.

12. The product providing device according to claim 3, wherein
on condition that the payment processing by the payment processing unit is completed, the second-type option presentation unit presents, in a non-selectable mode, a second-type option which is selected by a user and for which the payment processing is completed.

13. The product providing device according to claim 3, wherein
the second-type option presentation unit releases selection of the first-type option and the second-type option on condition that the payment processing by the payment processing unit is not performed within a predetermined time from selection of the second-type option.

14. The product providing device according to claim 2, wherein
the product group includes a first-type product associated with a second-type option and a second-type product not associated with the second-type option,
on condition that a user selects a last second-type option that is selectable and payment processing for the last second-type option is completed, the product providing unit presents product information of a second-type product to the user.

15. The product providing device according to claim 3, wherein
the first-type option presentation unit performs control to enable selection of a first-type option through a draw, instead of selection of the first-type option by a user, and
the second-type option presentation unit performs control to enable selection of a second-type option through a draw, instead of selection of the second-type option by a user.

16. The product providing device according to claim 1, wherein
the first-type option is an image imitating a lottery box, and
the second-type option is an image imitating a lottery ticket.

17. The product providing device according to claim 1, wherein
the first-type option presentation unit releases selection of a first-type option on condition that payment processing by the payment processing unit is completed.

18. The product providing device according to claim 17, wherein
the first-type option presentation unit controls one first-type option to be selectable by only one user.

19. A product providing device capable of communicating with a terminal of a user, comprising:
a first-image presentation unit which presents a first image associated with a product group including a plurality of products having a plurality of types, to be selectable by only one user;
a second-image presentation unit which presents a plurality of second images associated with the first image, to be selectable by only a user who has selected the first image;
a payment processing unit which performs payment processing for consideration corresponding to a number of at least one second image selected by the user; and
a product providing unit which presents, on the terminal, product information of at least one product corresponding to the number of at least one second image selected by a user after payment processing by the payment processing unit, wherein
each of the second images is associated with any one product of products of the product group without duplication,
the product providing unit presents, on the terminal, product information of a product associated with a second image selected by a user, and
after payment processing by the payment processing unit, the first-image presentation unit releases selection of the first image by the user and enables selection of the first image by another user.

20. A product providing system comprising:
a terminal and a product providing device capable of communicating with the terminal,
the product providing device includes:
a first-type option presentation unit which presents a plurality of first-type options on the terminal to be selectable by a user;
a second-type option presentation unit which presents, on the terminal, a plurality of second-type options associated with a first-type option selected by a user among the plurality of first-type options, to be selectable by a user;
a payment processing unit which performs payment processing for consideration corresponding to a number of at least one second-type option selected by a user; and
a product providing unit which presents, on the terminal, product information of at least one product corresponding to the number of at least one second-type option selected by a user after payment processing by the payment processing unit.
